(19) United States
(12) Patent Application Publication
(10) Pub. No.: US 2007/0024188 A1
(43) Pub. Date: Feb. 1, 2007

(54) Organic light emitting device and manufacturing method thereof

(76) Inventors: Tae-Whan Kim, Seoul (KR); Young-bae Yoon, Gunsan-si (KR)

Correspondence Address: CANTOR COLBURN, LLP, 55 GRIFFIN ROAD SOUTH, BLOOMFIELD, CT, 06002, US

(21) Appl. No.: 11/495,231

(22) Filed: Jul. 28, 2006

(30) Foreign Application Priority Data
Jul. 29, 2005 (KR) 10-2005-0069893

(51) Int. Cl. H01J 1/62; H01J 63/04

(52) U.S. Cl. 313/504

(57) ABSTRACT

An organic light emitting device, and a manufacturing method thereof, in which the organic light emitting device includes a mixture layer forming a stepwise concentration gradient by mixing a hole transport layer material and an electron transport layer material formed at an interface between an electron transport layer and an emission layer and also at an interface between a hole transport layer and the emission layer. The emission layer has a structure in which a unit layer and a quantum well layer are repeatedly laminated wherein the unit layer is formed by mixing the hole transport layer material, the electron transport layer material, and the material for transferring energy to the light emitting material, and then coated with the light emitting material.

This application claims priority to and the benefit of Korean Patent Application No. 10-2005-0069893, filed on Jul. 29, 2005, and all the benefits accruing therfrom under 35 U.S.C. § 119, the contents of which in its entirety are incorporated herein by reference.

### BACKGROUND OF THE INVENTION

(a) Field of the Invention

The present invention relates to an organic light emitting device and a manufacturing method thereof.

(b) Description of the Related Art

Recently, as the display size of display devices has increased, demand for flat panel display devices that occupy smaller spaces has also increased. An organic light emitting diode display has been rapidly developed as one of the flat panel display devices.

A charge injection characteristic on the interface between an organic light emitting material and an electrode has a great effect on the quantum efficiency and driving voltage of a light emitting device using those materials, and also significantly influences the lifespan of such a device. Therefore, research regarding organic light emitting devices generally concentrates on the interfacial charge injection characteristics of the device in order to improve the efficiency and lifespan of the device.

Regarding carrier mobility within organic matter, holes (the absence of an electron from an otherwise full valence band of an atom) are more easily moved than electrons due to reasons such as ionization potential and electron affinity. The result of this imbalance in mobility is that if a similar number of holes and electrons are formed on either end of the organic matter, the faster moving holes will pass through much of the organic matter before colliding with, and subsequently annihilating, an electron. In other words, since electrons are not easily moved within the organic matter, greater numbers of excitons (a bound state of an electron and an electron hole) are created near the cathode where the electrons originate. However, when the annihilation of the electron and the hole occurs near the electrodes no light is emitted from the exciton; a result that is sometimes called a non-radiative emission. This leads to degraded quantum efficiency of the organic light emitting device. The quantum efficiency is a measure of what percentage of annihilations between holes and electrons result in radiative emission.

Accordingly, in order to improve the efficiency of the device, a sufficient amount of electrons and holes must be injected into the emission layer and the injected electrons and holes must be balanced both in number and in location within the organic layer.

Due to the above-mentioned factors, in order to improve the efficiency of the organic light emitting device, research has been done to form a light emitting device with a hetero-junction structure using two or more organic materials with different band gaps. In the hetero-junction structure, a charge transport layer, namely an electron transport layer or a hole transport layer, is formed between the emission layer and the cathode and the anode, respectively. Although the mobility of electrons is lower than that of holes, a local charge density, or the amount of electrical charge per volume, can be increased in this structure by suppressing the mobility of holes, which enables easy injection of the electrons by a space charge field. In addition, a material with a good electron transport capability is employed, and thus electrons can more rapidly enter a collision radius beyond the cathode where the electrons may be combined with holes where the combination will result in radiative emission. Using these techniques it is possible to improve luminous efficiency.

However, the organic light emitting device of the multi-layer structure is problematic in that the hetero-junction interface itself limits the stability, or lifetime, of the device, an accumulation of spatial charges can cause a high deviation in the number of excitons created, and interfacial roughness reduces the lifespan of the device due to the incompatibility of two organic materials. Furthermore, in the case of a conventional organic light emitting device, the emission layer is used in a single layer scheme or a multi-layered scheme where the emission layer itself constitutes a relatively thin portion of the device. Therefore, problems arise because luminous efficiency is low, the width of a light emitting region is narrow, and colors may not be stabilized when the applied current increases. Accordingly, a solution for solving these problems is needed.

### BRIEF SUMMARY OF THE INVENTION

Exemplary embodiments of the present invention provide an organic light emitting device and a manufacturing method thereof, wherein the lifespan can be extended, luminous efficiency can be improved and colors can be stabilized.

According to an exemplary embodiment of the present invention, an organic light emitting device includes an anode, a hole transport layer disposed on the anode, a first mixture layer, an emission layer, a second mixture layer, an electron transport layer, and a cathode. The anode is disposed on a substrate and may be transparent. The hole transport layer is disposed on the anode. The first mixture layer is disposed on the hole transport layer and includes a hole transport material and an electron transport material. Each of the hole transport material and the electron transport material has a position-dependent concentration. The emission layer is disposed on the first mixture layer and includes a first mixture film and a second mixture film alternately arranged. The first mixture film includes a hole transport material, an electron transport material, an energy transfer material, and a light emitting material. The second mixture film includes a hole transport layer material, an electron transport material, and an energy transfer material. The second mixture layer is disposed on the emission layer and includes an electron transport material and a hole transport material. Each of the hole transport material and the electron transport material have a position-dependent concentration. The electron transport layer is disposed on the second mixture layer, and a cathode disposed on the electron transport layer.

According to an exemplary embodiment of the present invention, a method of manufacturing an organic light emitting device includes forming a transparent anode on a substrate, forming a hole transport layer on the anode, depositing a hole transport material and an electron transport material at different deposition rates on the hole transport layer to form a first mixture layer, alternately and repeatedly depositing a first mixture film and a second mixture film on the first mixture layer to form an emission layer, the first mixture film including a hole transport material, an electron transport material, an energy transfer material, and a light emitting material, and the second mixture film including a hole transport layer material, an electron transport layer material, and an energy transfer material, depositing an electron transport material and a hole transport material at different deposition rates on the emission layer, thereby forming a second mixture layer, forming an electron transport layer on the second mixture layer, and forming a cathode on the electron transport layer.

### BRIEF DESCRIPTION OF THE DRAWINGS

FIG. 1 is a schematic cross-sectional diagram of an exemplary embodiment of an organic light emitting device according to the present invention.

FIG. 2 is a schematic diagram showing energy bands of the cross-sectional layers of the exemplary embodiment of an organic light emitting device shown in FIG. 1.

FIG. 3 is a schematic cross-sectional diagram of an exemplary embodiment of an organic light emitting device and a corresponding graph illustrating the distribution of materials within the exemplary embodiment of the organic light emitting device according to the present invention.

FIG. 4 is a graph illustrating measured current density as a function of applied voltage in organic light emitting devices having different structures.

FIG. 5 is a graph illustrating measured luminance as a function of applied voltage in organic light emitting devices having different structures.

FIG. 6 is a graph illustrating measured efficiency as a function of current density in organic light emitting devices having different structures.

FIG. 7 is a graph illustrating measured luminous intensity of organic light emitting devices as a function of time having different structures.

### DETAILED DESCRIPTION OF THE INVENTION

The present invention is described more fully hereinafter with reference to the accompanying drawings, in which exemplary embodiments of the present invention are shown. The present invention may, however, be embodied in many different forms and should not be construed as limited to the exemplary embodiments set forth herein. Rather, these exemplary embodiments are provided so that this disclosure will be thorough and complete, and will fully convey the scope of the present invention to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented 30 “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular exemplary embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments of the invention are described herein with reference to cross-section illustrations that are schematic illustrations of idealized exemplary embodiments (and intermediate structures) of the present invention. As such, variations from the shapes of the illustrations as a result, for example, of manufacturing techniques and/or tolerances, are to be expected. Thus, exemplary embodiments of the present invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention now will be described more fully hereinafter with reference to the accompanying drawings, in which preferred embodiments of the invention are shown. The present invention may, however, be embodied in many different forms and should not be construed as limited to the embodiments set forth herein.

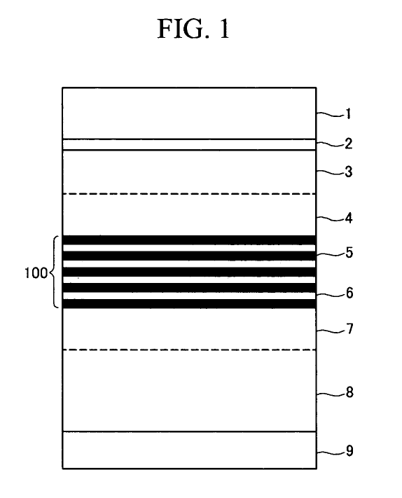

FIG. 1 is a schematic sectional view of an organic light emitting device according to an exemplary embodiment of the present invention.

Referring to FIG. 1, an organic light emitting device according to an exemplary embodiment of the present invention includes an anode 9, a cathode 1, and an emission layer 100 disposed between the anode 9 and the cathode 1. The organic light emitting device further includes a pair of mixture layers 4 and 7, a hole transport layer 8, an electron transport layer 3, and an electron injection layer 2. The mixture layer 4 is located between the emission layer 100 and the cathode 1, the mixture layer 7 is located between the emission layer 100 and the anode 9, the hole transport layer 8 is located between the mixture layer 7 and the anode 9, the electron transport layer 3 is located between the mixture layer 4 and the electron injection layer 2, and the injection layer 2 is located between the electron transport layer 3 and the cathode 1.

The emission layer 100 includes a plurality of first mixture films 5 and a plurality of second mixture films 6, which are laminated on top of one another in an alternating manner.

Each layer of the first mixture films 5 includes a hole transport material, an electron transport material, and an energy transfer material along with a light emitting material (or fluorescent dopant). Each layer of the second mixture films 6 includes a hole transport material, an electron transport material, and an energy transfer material, but does not include a light emitting material. The second mixture film 6 may also be referred to as “quantum well film.”

Exemplary embodiments of the light emitting material may include 4-(dicyanomethylene)-2-t-butyl-6-(1,1,7,7-tetramethyljulolidyl-9-enyl)-4H-pyran (DCJTB), Pt(II)octaethyl porphyrin (PtOEP), [2-methyl-6-[2-(2,3,6,7-tetrahydro-1H,5H-benzo[ij]quinolizin-9-yl)ethenyl]-4H-pyran-4-ylidene]propane-dinitrile (DCM2), and 9-Benzothiazol-2-yl-1,1,6,6-tetramethyl-2,3,5,6-tetrahydro-1H,4H-11-oxa-3a-aza-benzo[de]anthracene-10-one (C545T).

The energy transfer material can transfer energy to the light emitting material. Exemplary embodiments of the energy transfer material may include 5,6,11,12-tetraphenyl naphthalene (Rubrene), Quinacridone, Batrachotoxinin-A,N-methylanthranilate (BTX), and 3-(dicyanomethylene)-5,5-dimethyl-1-[(4-dimethylamino)styryl]cyclohexene (DCDDC).

Exemplary embodiments of the hole transport material may include N,N′-diphenyl-N,N′-bis(1-naphthyl)-(1,1′-biphenyl)-4,4′-diamine (NPB), N,N′-diphenyl-N,N′-bis(3-methylphenyl)-(1,1′-biphenyl)-4,4′-diamine (TPD), 11,11,12,12-tetracyano-9,10-anthraquinodimethane (disclosed in Synth. Met. 85, 1267, (1997)), a distyryl triphenylene compound (disclosed in Synth. Met. 91, 257, (1997)), 1,3,5-tris-(N,N-bis-(4,5-methoxy-phenyl)-aminophenyl)-benzene (disclosed in Synth. Met. 111-112, 263, (2000)), N,N′bis(4-(2,2-diphenylethenyl)-phenyl)-N,N′di(p-tolyl)-bendidine (DPS) and derivatives thereof, and 4,4′4″-tris(diphenylamino)triphenylamine (TDATA) and derivatives thereof.

Exemplary embodiments of the electron transport material may include tris-(8-hydroxyquinoline)aluminum (Alq3), 3-(4-biphenylyl)-4-phenyl-5-(4-tert-butylphenyl)-1,2,4-triazole (TAZ), [2-(4-biphenylyl)-5-(4-tert-butylphenyl)-1,3,4-oxadiazole](PBD), bis(10-hydroxybenzo[h]quinolinato)beryllium (Bebq2), 2,2,2′(1,3,5-benzenetriyl)tris-[1-phenyl-1H-benzimidazole](TPBI), aluminum(III) bis(2-methyl-8-quinolinato)4-phenylphenolate (Balq), and 2,9-dimethyl-4,7-diphenyl-1,10-phenanthroline (BCP).

This configuration of the emission layer 100, which comprises several layers of first and second mixture films, can increase the efficiency of light emission. The color saturation, the light intensity and how broad its wavelength distribution is, of light emitted from the emission layer 100 can be increased by adjusting the wavelength range of the emitted light, which can be controlled by adjusting the type, the number, the location, and the thickness of the first and the second mixture layers 5 and 6.

The anode 9 performs hole injection and thus the anode 9 may be made of a material that has a high work function, e.g., a material that requires a large amount of energy to remove an electron from it to a point immediately outside its surface. In addition, the anode 9 may be made of a transparent conductor that allows light emitted from the emission layer 100 to pass through it. An example of the material for the anode 9 may include a transparent metal oxide such as indium tin oxide (ITO). Alternative exemplary embodiments include configurations where the anode 9 may include indium zinc oxide (IZO). The anode 9 may have a thickness of about 150 nm.

The cathode 1 may be made of a material having a low work function, e.g., a material that requires a small amount of energy to remove an electron, including metals such as Ca, Mg, and Al.

The hole transport layer 8 is disposed between the anode 9 and the emission layer 100 and may be made of at least one of the above-described hole transport materials. The hole transport layer 8 may have a thickness of about 30 nm to about 60 nm.

The electron transport layer 3 is disposed between the cathode 1 and the emission layer 100 and may be made of at least one of the above-described electron transport materials. The electron transport layer 3 may have a thickness of about 20 nm to about 50 nm.

The mixture layer 7 is disposed between the hole transport layer 8 and the emission layer 100, and the mixture layer 4 is disposed between the electron transport layer 3 and the emission layer 100. Each of the mixture layers 4 and 7 includes one of the above-described hole transport materials and one of the above-described electron transport materials. The mixture layers 4 and 7 have a stepwise or monotonous gradient in the concentration of the hole transport material and the electron transport material. The concentration of the hole transport material in the mixture layer 7 decreases as it goes from the hole transport layer 8 to the emission layer 100, and the concentration of the electron transport material in the mixture layer 4 decreases as it goes from the electron transport layer 3 to the emission layer 100.

The concentration of the hole transport material to the electron transport material in the mixture layer 7 may begin with a concentration ratio of about 1:0 at the boundary between the mixture layer 7 and the hole transport layer 8, and may decrease as it approaches the boundary between the mixture layer 7 and the emission layer 100 where the concentration ratio of the hole transport material and the electron transport material in the mixture layer 7 is substantially equal to that in the emission layer 100. The concentration of the electron transport material in the mixture layer 4 may show substantially the same distribution, starting with a concentration ratio compared to the hole transport layer of about 1:0 at the boundary between the mixture layer 4 and the electron transport layer 3, and decreasing as it approaches the boundary between the mixture layer 4 and the emission layer 100, where the concentration ratio of the electron transport material and the hole transport material in the mixture layer 4 is substantially equal to that in the emission layer 100.

In one exemplary embodiment, the emission layer 100 includes NPB as the hole transport material and Alq3 as the electron transport material, the concentration ratio of which is equal to about 1:1. Then, the mixture layer 7 may include (100-y1) concentration % of NPB and y1 concentration % of Alq3, where y1=0 at the boundary between the mixture layer 7 and the hole transport layer 8, y1=50 at the boundary between the mixture layer 7 and the emission layer 100, and 0<y1<50 in between. Similarly, the mixture layer 4 may include (100-y2) concentration % of Alq3 and y2 concentration % of NPB, where y2=0 at the boundary between the mixture layer 4 and the electron transport layer 3, y2=50 at the boundary between the mixture layer 4 and the emission layer 100, and 0<y2<50 in between.

This concentration distribution, which gradually mixes the different transport layers, may remove the hetero-junction structure between the contacting layers to facilitate hole and electron injections therebetween, and can also obviate a local electric field effect due to a difference in the energy gap between the layers. Therefore a malfunction of the device between the transport layers and the emission layer is reduced, or effectively prevented.

According to an exemplary embodiment of the present invention, the electron injection layer 2 may be a thin film of LiF or Li₂O, or may include an alkali metal or an alkaline earth metal, such as Li, Ca, Mg, and Sr. The electron injection layer 2 may be used to improve the electron injection function. Alternative exemplary embodiments include configurations where the electron injection layer 2 may be omitted.

An exemplary embodiment of a method of manufacturing the organic light emitting device shown in FIG. 1 according to the present invention will be described in detail.

An anode 9 made of ITO is formed on a substrate (not shown) such as transparent glass or plastic by sputtering, or another suitable technique.

A hole transport layer 8 is formed on the anode 9. A hole transport material and an electron transport material, which may be organic, are grown at the same time to form a mixture layer 7 having a stepwise or monotonous concentration gradient so that the energy gap between the highest occupied molecular orbital (“HOMO”) level and the lowest unoccupied molecular orbital (“LUMO”) level of the mixture layer 7 matches the levels of the materials that immediately border it, both above and below. Specifically, only the hole transport material is to be grown immediately on the hole transport layer 8. The growing rate of the hole transport material is then decreased, while the growing rate of the electron transport material is increased, and the growth of the hole transport material and the electron transport material continues until the growing rate of the electron transport material approaches the growing rate of the hole transport material.

Next, a first mixture film 5 is formed by growing a hole transport material, an electron transport material, and an energy transfer material at the same rate while being doped with a light emitting material. Subsequently, a second mixture film 6 including a hole transport material, an electron transport material, and an energy transfer material are formed. The first and the second mixture films 5 and 6 are alternatively and repeatedly deposited to form an emission layer 100.

A hole transport material and an electron transport material are grown on the emission layer 100 beginning with the same growth rate. The growing rate of the electron transport material is then increased, while the growing rate of the hole transport material is decreased until the growing rate of the hole transport material reaches zero, thereby forming another mixture layer 4.

Subsequently, an electron transport layer 3, an electron injection layer 2, and a cathode 1 are sequentially deposited.

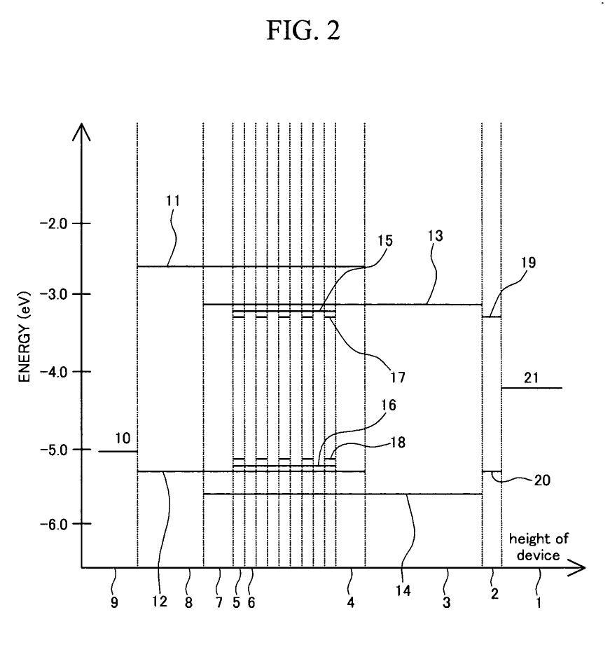

FIG. 2 shows energy levels corresponding to the above-described materials. The ordinate of the graph shows the energy levels corresponding to the work functions, HOMOs and LUMOs of the various materials in electron volts (eV). The abscissa follows the structure of the exemplary embodiment of a light emitting device as described above and using exemplary embodiments of the materials suggested for each level as described above. The energy levels are as follows: 10: work function of ITO; 11: LUMO level of NPB; 12: HOMO level of NPB; 13: LUMO level of Alq3; 14: HOMO level of Alq3; 15: LUMO level of Rubrene; 16: HOMO level of Rubrene; 17: LUMO level of DCJTB; 18: HOMO level of DCJTB; 19: LUMO level of Liq; 20: HOMO level of Liq; and 21: work function of Al.

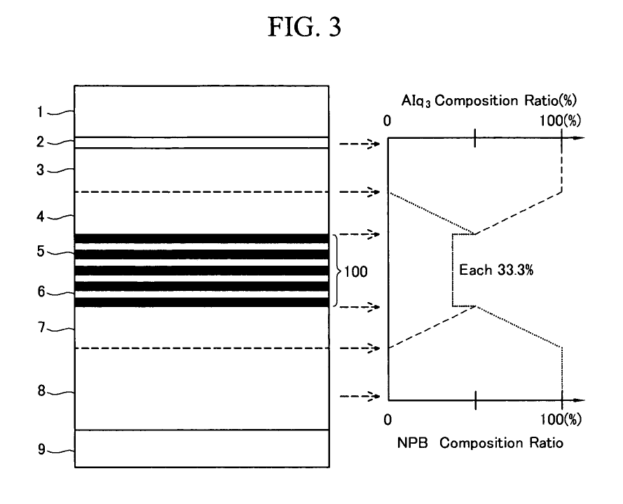

FIG. 3 is a schematic cross-sectional diagram of an exemplary embodiment of an organic light emitting device and a corresponding graph illustrating the distribution of materials within the exemplary embodiment of the organic light emitting device according to the present invention. Referring to FIG. 3, the schematic cross-sectional diagram on the left is similar in structure to the exemplary embodiments described above. The graph on the right illustrates the concentration ratio of Alq3 and NPB within the exemplary embodiment, as dashed and dotted lines, respectively.

According to an exemplary embodiment of the present invention, NPB was used as a hole transport material, Alq3 was used as an electron transport material, and Rubrene was used as an energy transfer material. The concentration ratio (determined in this exemplary embodiment by weight) of NPB, Alq3, and Rubrene in the first and the second mixture film 5 and 6 was 1:1:1. DCJBT of about 3 concentration % was used as a light emitting material in the first mixture film 5. An organic light emitting device manufactured by the above-described materials and emitting light in a red part of the visible spectrum range exhibited high performance.

When the concentration ratio of the hole transport material and the electron transport material in the emission layer 100 is equal to about 1:1, the balance between holes and electrons therein becomes favorable for creating excitons therein. Accordingly, the efficiency and the current density therein may also be excellent.

If it is modeled that one hole occupies one molecule in the hole transport material and then jumps in a direction, and one electron occupies one molecule in the electron transport material and then jumps in a direction opposite to the jumping direction of the hole, a ratio 1:1 of the hole transport material and the electron transport material in the emission layer 100 can give the highest efficiency.

Furthermore, the reason why the energy transfer material, one exemplary embodiment of which is Rubrene, is mixed in the same composition ratio as the hole transport material or the electron transport material can be described as follows. The emission layer 100 emits light of about the same energy as the excitons generated therein. In an exemplary embodiment, the emission layer 100 emits light according to the energy level of Rubrene molecules. It is important that the energy transfer material be included according to the 1:1:1 ratio with the hole transport material and the electron transport material in the mixture layers 5 and 6 in order to make the generated excitons as many as possible to contribute to light emission.

However, if the concentration ratio of the hole transport material and the electron transport material is not equal to 1:1, an attenuation phenomenon of light emission, a reduction of current density and current efficiency, and a reduction of power efficiency may occur because a larger number of either electrons or holes would be introduced into the emission layer and such an imbalance would mean that not all of the electrons or holes would be able to find a counterpart therein with which to form an exciton.

The combination of the light emitting material as a “dopant” and other materials as a “host” may be very effective for the emission of red light. As compared with an emission layer of a single material configuration, the combinational configuration increases the color saturation and the emission efficiency of the emission layer 100.

Hereinafter, the present invention is described in detail through Examples and Experiments. However, the following Examples are only for the understanding of the present invention, and the present invention is not limited to the following Examples.

### EXAMPLE 1

### Manufacture of Organic Light Emitting Device <1-1> Manufacture of Anode

An ITO thin film having a thickness of about 100 nm to about 150 nm and having a sheet resistance of about 30 Ω/cm² was grown on a glass substrate (not shown) by deposition to form an anode 9.

<1-2> Manufacture of Hole Transport Layer

NPB was deposited at 30 nm in thickness under a vacuum of about 10⁻⁷ Torr to about 10⁻⁹ Torr to form a hole transport layer 8. At this time, the growth rate was kept to be about 0.1 nm/seconds in order to grow a thin film of high quality.

<1-3> Manufacture of First Stepwise Concentration Distribution Mixture Layer

A mixture layer 7 including NPB and Alq3 was deposited to a thickness of about 10 nm at a vacuum degree of about 10⁻⁷ Torr to about 10⁻⁹ Torr while gradually decreasing the growth rate of NPB, so that it transitioned from 1 Å/sec, to 0.9 Å/sec, to 0.8 Å/sec, and so on, and gradually increasing the growth rate of Alq3, so that it transitioned from 0 Å/sec, to 0.1 Å/sec, to 0.2 Å/sec, and so on, such that the composition ratio of materials mixed in the mixture layer 7 may change stepwise.

<1-4> Manufacture of Emission Layer (Including Quantum Well Film)

NPB, Alq3, Rubrene, and DCJTB were simultaneously grown on the mixture layer 7 under a vacuum of 10⁻⁷ Torr to 10⁻⁹ Torr. At this time, the injection of DCJTB was periodically performed to obtain alternate lamination structure of first and second mixture films 5 and 6. The deposition rate of each of NPB, Alq3, and Rubrene was equal to about 0.32 Å/sec and the growth rate of DCJTB was equal to about 0.03 Å/sec.

<1-5> Manufacture of Second Stepwise Concentration Distribution Mixture Layer

A mixture layer 4 including Alq3 and NPB was deposited to about 10 nm in thickness at a vacuum of about 10⁻⁷ Torr to about 10⁻⁹ Torr while gradually decreasing the growth rate of NPB, so that it transitioned from about 0.32 Å/sec, to 0.2 Å/sec, to 0.1 Å/sec, and so on, and gradually increasing the growth rate of Alq3, so that it transitioned from about 0.32 Å/sec, to 0.5 Å/sec, to 0.6 Å/sec, and so on, so that the concentration ratio of materials mixed in the mixture layer 4 became a stepwise distribution.

<1-6> Manufacture of Alq3 Electron Transport Layer

Alq3 was deposited in a vacuum to a thickness of about 20 nm on the mixture layer 4 to form an electron transport layer 3. The electron transport layer 3 with a high quality was grown in a vacuum of about 10⁻⁷ Torr to about 10⁻⁹ Torr and at the growth rate of about 0.1 nm/seconds.

<1-7> LiF Electron Injection Layer and Manufacture of Cathode

LiF was deposited to a thickness of about 2 nm in a vacuum of about 10⁻⁷ Torr to about 10⁻⁹ Torr and at the growth rate of about 0.1 nm/seconds to form an electron injection layer 2, and Al was then deposited to form a cathode 1 having a thickness of 100 nm.

### EXPERIMENTAL EXAMPLES

### Efficiency of Organic Light Emitting Device

<1-1> Measured Current Density as a Function of Voltage in Organic Light Emitting Device

In addition to the organic light emitting device (denoted by Structure III) manufactured by the above-described method, a conventional organic light emitting device (denoted by Structure I) having hetero-junctions, and another organic light emitting device (denoted by Structure II) in which DCJTB was added into a host-mixture of NPB and Alq3 having a ratio of 1:1, but lacking a multiple quantum well film (e.g., the second mixture film 6), were fabricated. The organic light emitting device having Structure II also have hetero-junctions like Structure I. The above-described organic light emitting devices were made of substantially the same materials and had substantially the same structure except for the above-described features. In order to measure the efficiencies of the organic light emitting devices of the three structures, the current density was measured from 0 to 15V every 0.5V using a Source-Measure Unit, model 236, manufactured by Keithley Instruments Inc. (hereinafter, “the Keithley”).

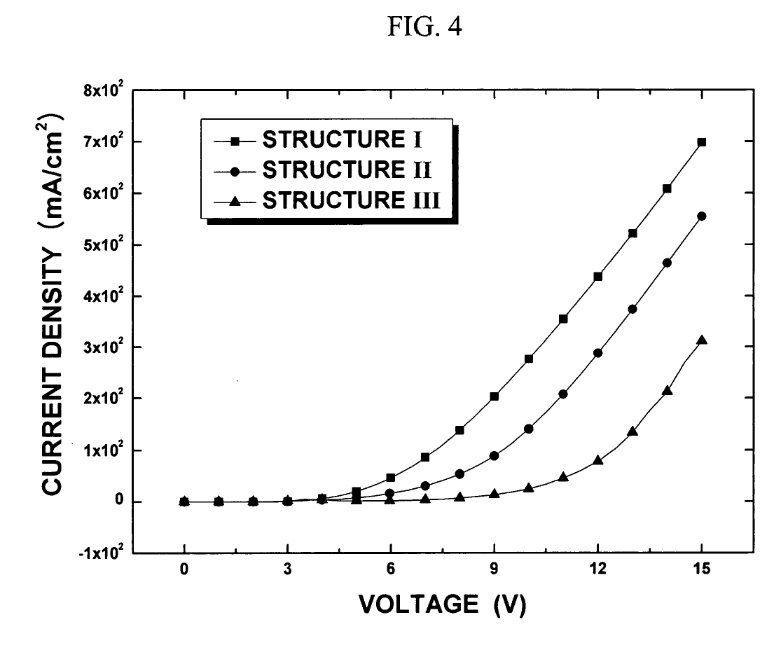

FIG. 4 is a graph showing the measured current density as a function of voltage. FIG. 4 shows that a turn-on voltage at which the organic light emitting device starts to emit light is about 2.6V in the device of the structure I, about 2.8V in the device of the structure II, and about 3.0V in the device of the structure III. It is understood that the turn-on voltage of the organic light emitting device of Structure III was increased because holes are confined in the well of the light emitting layer 100 and may have decreased mobility as compared with Structure II.

<1-2> Measurement of Luminance as a Function of Voltage Applied to the Organic Light Emitting Device

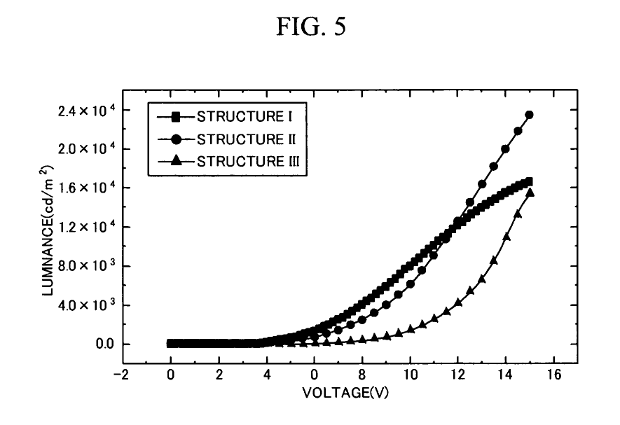

Luminance of the organic light emitting devices of the three structures was measured using a luminance measurement system, particularly the Chroma Meter CS-100A manufactured by Konica Minolta, within a dark box while applying voltages ranging from about 0V to about 15V between the anode 9 and the cathode 1 employing the Keithley. The measured values are shown as a function of applied voltage in FIG. 5. The device of structure I had a maximum luminance of about 16,590 cd/M² at about 15V and the device of the structure II had a maximum luminance of about 23,400 cd/m² at about the same voltage. The high luminance of structure II may be caused by the addition of a dopant with a high luminous efficiency. The organic light emitting device of the exemplary embodiment of the present invention (structure III) had a luminance high of about 15,500 cd/m² at about 15V. Although not shown, both the structure II and the structure III have a color coordinate (0.5, 0.5) in the CIE 1931 color space, corresponding to a yellow region, because the same dopant DCJTB was added, and they can provide a stabilized color coordinate in which the wavelength of peak electroluminescence (“EL”) is not significantly changed with an increase in voltage.

<1-3> Measured Current Efficiency as a Function of Current Density of an Organic Light Emitting Device

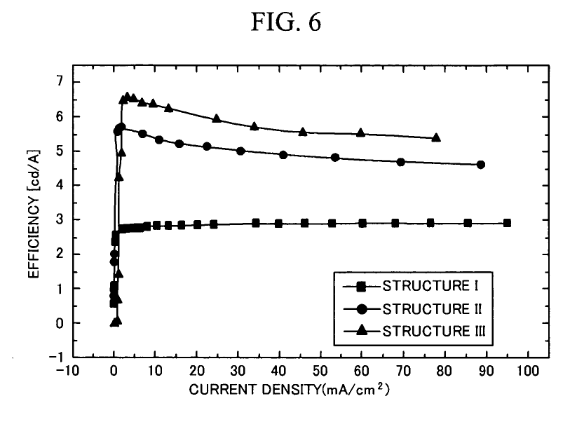

FIG. 6 is a graph showing the current density versus the current efficiency based on the measured values of the Experimental Examples <1-1> and <1-2>. From FIG. 6, it can be seen that the device of structure I having hetero-junctions shows a constant current efficiency of about 2.9 cd/A as the current is increased, but the device of structure II shows a maximum efficiency of about 5.7 cd/A at about 3 mA/cm². It can also be seen that the organic light emitting device of the exemplary embodiment of the present invention shows a maximum efficiency of about 6.57 cd/A at about 3 mA/cm² and the efficiency is not significantly lowered as the current increases.

<1-4> Measured Lifespan of Organic Light Emitting Device

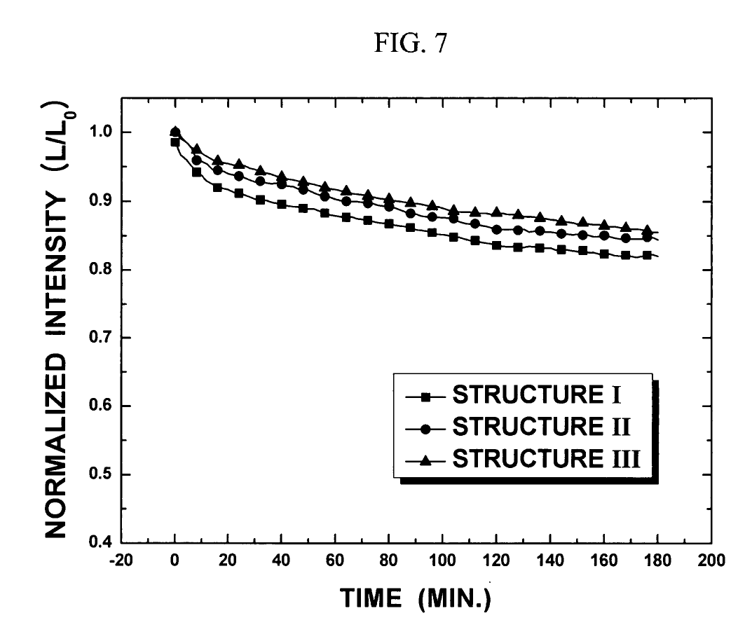

The luminance and operation voltages of the devices having the three structures were measured using a homemade lifespan measurement device including silicon photodiodes. Both luminance and operation voltages will gradually decrease with the age of the device. FIG. 7 is a graph illustrating a temporal variation of normalized intensity gradually decreasing with time. The initial luminance of all three devices was equal to about 1,000 cd/m². The structure I having the hetero-junctions shows the fastest degradation with time. From FIG. 7, it can be seen that the organic light emitting devices having structure II and structure III show a slower degradation of the intensity than structure I. This more gradual degradation may be caused by the mixture of different materials in the emission layer 100. The organic light emitting devices having structure II and structure III show similar degradation degrees. The reason why the lifespan is increased is understood to be that Alq3⁺ positive ions, which accelerate the degradation of the device, are generated less frequently than in the device of structure I.

As described above, in the exemplary embodiment of an organic light emitting device according to the present invention, a stepwise concentration gradient is formed at the interface between the emission layer and the hole transport layer and also at the interface between the emission layer and the electron transport layer. Accordingly, hole and electron injection through the layer junctions can be facilitated, a local electric field phenomenon due to the difference in the energy gap can be eliminated, and the lifespan of the device can be enhanced accordingly. Furthermore, the emission layer is formed by repeatedly laminating a quantum well film, e.g., the second mixture film 6, on the first mixture film 5. The first mixture film 5 is formed by mixing the hole transport material, the electron transport material, and the energy transfer material and then by doping the mixture with the light emitting material. Accordingly, luminous efficiency can be enhanced and colors can be stabilized.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An organic light emitting device comprising:
an anode;
a hole transport layer disposed on the anode;
a first mixture layer disposed on the hole transport layer and comprising a hole transport material and an electron transport material, each of the hole transport material and the electron transport material having a position-dependent concentration;
an emission layer disposed on the first mixture layer and comprising a first mixture film and a second mixture film alternately arranged, the first mixture film comprising a hole transport layer material, an electron transport layer material, an energy transfer material, and a light emitting material, and the second mixture film comprising a hole transport layer material, an electron transport layer material, and an energy transfer material;
a second mixture layer disposed on the emission layer and comprising an electron transport material and a hole transport material, each of the hole transport material and the electron transport material having a position-dependent concentration;
an electron transport layer disposed on the second mixture layer; and
a cathode disposed on the electron transport layer.

2. The organic light emitting device of claim 1, wherein each of the hole transport material and the electron transport material in the first and the second mixture layers has a stepwise concentration gradient.

3. The organic light emitting device of claim 2, wherein the concentration of the hole transport material in the first mixture layer decreases from the hole transport layer to the emission layer, and the concentration of the electron transport material in the first mixture layer increases from the hole transport layer to the emission layer.

4. The organic light emitting device of claim 3, wherein a concentration ratio of the hole transport material to the electron transport material in the first mixture layer is substantially equal to 1:0 at a boundary between the first mixture layer and the hole transport layer, and the concentration ratio is substantially equal to a concentration ratio of the hole transport material and the electron transport material in the emission layer at a boundary between the first mixture layer and the emission layer.

5. The organic light emitting device of claim 3, wherein the concentration of the electron transport material in the second mixture layer decreases from the electron transport layer to the emission layer, and the concentration of the hole transport material in the second mixture layer increases from the electron transport layer to the emission layer.

6. The organic light emitting device of claim 5, wherein a concentration ratio of the electron transport material and the hole transport material in the second mixture layer is substantially equal to 1:0 at a boundary between the second mixture layer and the electron transport layer, and substantially equal to a concentration ratio between the electron transport material and the hole transport material in the emission layer at a boundary between the second mixture layer and the emission layer.

7. The organic light emitting device of claim 5, wherein the concentration ratio of the energy transfer material, the electron transport material, and the light emitting material in the emission layer is equal to about 1:1:1.

8. The organic light emitting device of claim 1, wherein the light emitting material is at least one material selected from the group comprising 4-(dicyanomethylene)-2-t-butyl-6-(1,1,7,7-tetramethyljulolidyl-9-enyl)-4H-pyran(DCJTB), Pt(II)octaethyl porphyrin(PtOEP), [2-methyl-6-[2-(2,3,6,7-tetrahydro-1H,5H-benzo[ij]quinolizin-9-yl)ethenyl]-4H-pyran-4-ylidene]propane-dinitrile(DCM2), and 9-Benzothiazol-2-yl-1,1,6,6-tetramethyl-2,3,5,6-tetrahydro-1H,4H-11-oxa-3a-aza-benzo[de]anthracene-10-one (C545T).

9. The organic light emitting device of claim 1, wherein the energy transfer material is at least one material selected from the group comprising 5,6,11,12-tetraphenyl naphthalene (Rubrene), Quinacridone, Batrachotoxinin-A,N-methylanthranilate (BTX), and 3-(dicyanomethylene)-5,5-dimethyl-1-[(4-dimethylamino)styryl]cyclohexene (DCDDC).

10. The organic light emitting device of claim 1, wherein the anode is transparent.

11. The organic light emitting device of claim 1, wherein each of the hole transport material and the electron transport material in the first and the second mixture layers has a constant, non-zero, concentration gradient.

12. The organic light emitting device of claim 1 further comprising an electron injection layer disposed between the electron transport layer and the cathode.

13. A method of manufacturing an organic light emitting device, the method comprising:
forming a transparent anode on a substrate;
forming a hole transport layer on the anode;
depositing a hole transport material and an electron transport material at different deposition rates on the hole transport layer to form a first mixture layer;
alternately and repeatedly depositing a first mixture film and a second mixture film on the first mixture layer to form an emission layer, the first mixture film comprising a hole transport material, an electron transport material, an energy transfer material, and a light emitting material, and the second mixture film comprising a hole transport layer material, an electron transport layer material, and an energy transfer material;
depositing an electron transport material and a hole transport material at different deposition rates on the emission layer, thereby forming a second mixture layer;
forming an electron transport layer on the second mixture layer; and
forming a cathode on the electron transport layer.

14. The method of claim 13, wherein the deposition rates of the hole transport material and the electron transport material in the first and the second mixture layers gradually vary with time.

15. The method of claim 14, wherein the deposition rate of the hole transport material for forming the first and the second mixture layers decrease and the deposition rate of the electron transport material for forming the first and the second mixture layers increase, with time.

16. The method of claim 15, wherein the deposition rates of the hole transport material and of the electron transport material for forming the emission layer and the deposition rates of the hole transport material and of the electron transport material at interfaces between the first mixture layer and the emission layer and between the second mixture layer and the emission layer are substantially the same and are do not vary with time.
